(19) United States
(12) Patent Application Publication
(10) Pub. No.: US 2004/0165743 A1
(43) Pub. Date: Aug. 26, 2004

(54) Otoplasty for behind-the-ear (BTE) hearing aids

(76) Inventor: Erich Bayer, Straubing (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/790,126

(22) Filed: Mar. 2, 2004

Related U.S. Application Data
(63) Continuation of application No. 10/030,191, filed on Jun. 6, 2002, now abandoned.
Application No. 10/030,191 is a 371 of international application No. PCT/EP00/10109, filed on Oct. 13, 2000.

(30) Foreign Application Priority Data
Oct. 14, 1999 (DE) 299 18 139.1
Jun. 2, 2000 (DE) 200 09 908.6

(51) Int. Cl. H04R 11/04; H04R 21/02

(52) U.S. Cl. 381/330; 381/312

(57) ABSTRACT

The invention relates to an otoplastic for production of behind-the-ear hearing aids. Said hearing aid comprises a preferably flexible signal conductor, such as e.g. an acoustic tube (28) which can be positioned in the auditory canal, whereby the otoplastic matches the individual anatomy of the patient and its locating part is essentially in the form of a clip, which, at least partly arched, follows the outer edge (36) of the cavum conchae (22). A branch (32) which follows the edge of the cavum conchae transforms, above the antitragus(30), into a bent crosspiece (34) which traverses the cavum conchae and runs in the direction of the porus acusticus externus. The end section (40) of said crosspiece (34) lies in the upper section of the auditory canal (26) and widens to accept the signal conductor (42).

The invention relates to an ear fitting piece, i.e. an earpiece for behind-the-ear (BTE) devices in the field of hearing acoustics. These devices are also frequently referred to as BTE-secret ears (SE). In this connection, a relatively short sound tube is used, making it possible to noticeably reduce friction losses, particularly in the high-frequency sonic range.

However, the sound tube must be precisely positioned in or on the auditory canal, and for this purpose, an ear fitting piece, i.e. an earpiece is regularly used, which is individually adapted to the human anatomy of the ear of the patient to be treated. Up to the present date, various forms of earpieces have become common, with some, namely the so-called “open” BTE earpieces, being particularly preferred, in order to have the minimum possible effect on the auditory canal, caused by partially covering or closing it off in some regions, with a “foreign body.” These “open” BTE devices have the further advantage that the hearing capacity that still exists is impaired as little as possible in terms of its natural effect.

Known relevant earpieces are known as “SE shell shape, SE clip shape, or SE claw shape” (See Ulrich Voogdt: Otoplastik—Die individuelle Otoplastik zur Hörgeräte-Versorgung . . . [Earpieces—Individual earpieces for hearing aids . . . ], Volume 2 of the scientific series “Akademie für Hörgeräte-Akustik” [Academy for hearing device acoustics], Median-Verlag of Killisch-Horn GmbH, 1993). A modified version of these common earpieces is the “open” solution. However, all of the variants have the common feature that it is frequently not possible to make the hearing correction as natural as possible.

It is therefore the task of the invention to create an earpiece for “open” BTE hearing aids, for CI components (cochlear implant microphone systems and CI BTE processors), or BTE tinnitus systems, which are characterized not only by a minimal feeling of wearing a foreign body, and good wearing comfort, but primarily in that natural sound processing in the human ear can be utilized with as little distortion as possible, in order to ensure a maximum degree of hearing correction and sense of natural hearing.

This task is accomplished by an earpiece according to Claim 1 and/or according to Claim 5.

With the earpiece according to the invention, in accordance with Claim 1, it is possible to keep the auditory canal open at the decisive points, to a degree that has not been achieved until now. The invention is based on the consideration that the sense of natural hearing, on the one hand, and the effectiveness of the hearing correction, on the other hand, are significantly influenced by the anatomically determined, natural resonance conditions in the auditory canal, including the external ear. Using the structure of the earpiece according to the invention, the natural resonance remains largely unaffected, even if the auditory canal is very narrow. In this connection, there are the additional advantages that the wearing comfort is extremely good (material-free region in the region of the crus helicis; no accumulation of heat), that the earpiece requires very little material and therefore also has cosmetic advantages, and that acoustic coupling for influencing the frequency and the dynamics can take place more free of complications.

Although the earpiece according to the invention takes up less room, it can reliably fulfill the function of stabilizing the sound tube, in that the coupling between the sound tube and the BTE device is utilized for stabilization.

It has been shown that the support elements of the earpiece are positioned in such a stable manner, in spite. of the reduced contact area with the cavum conchae, that the end segment of the earpiece traverse part can carry an. auditory canal tab, in accordance with the further development in Claim 2, making it possible to achieve better support in the auditory canal.

The task stated above is accomplished in accordance with a second alternative in accordance with Claim 5, in that the earpiece is, for the first time, positioned at a location of the external ear that lies entirely outside of the cavum conchae. It has surprisingly been shown that when positioning the part of the earpiece that provides the hold in the cymba, it is easily possible, in interaction with the inherent stability of the flexible signal conductor or the sound tube, to precisely and reproducibly position the latter in the auditory canal, which is no longer blocked off by an earpiece component, according to the invention. In this way, this earpiece is particularly well suited, in addition to “open” standard applications, for applications in children with deafness in one ear, or, for example, for students with normal hearing but with a so-called reading/spelling. weakness, in connection with so-called FM (frequency modulation) systems in which the teacher's speaking signal is fed into the auditory canal of the hearing-challenged child via a microphone. and a microport system. Particularly in this case, utilization of the natural auditory canal resonance is very important, and this is achieved by the earpiece according to the invention, to a degree that has not been achieved until now. Because of the improved general conditions, it is furthermore easier to undertake acoustical coupling of the hearing device to the frequency and dynamics influencing system, so that the earpiece according to the invention is also well suited for use in media, e.g. during live television interviews, as a type of “in-ear monitoring,” where in this case, a simultaneous translation, for example, or the voice signal of a prompter, are fed into the auditory canal under the most natural conditions possible.

A particular advantage of the earpiece according to Claim 5 can be seen in that there is great freedom with regard to the structure of the clip that goes around the external ear in the shape of an arc, which in turn can be utilized for additional stabilization of the earpiece. The further development according to Claim 6 goes in this direction.

If the main body of the earpiece that provides the hold is extended into the region. of the crus anthelicis, according to Claim 7, stabilization of the main body is further improved, which makes it possible to further reduce the size of the main body. At the same time, this improves the wearing comfort, and it also has advantages in terms of cosmetics.

This embodiment, also, just like the embodiment according. to Claim 1, has the advantage that it can be used without complications for specific special applications, such as a very narrow auditory canal or a lot of hair at the end of the auditory canal, or other anomalies of the ear anatomy.

Further developments of the invention are the object of the other dependent claims.

In the following, exemplary embodiments of the invention will be explained in greater detail, using the schematic drawings. These show:

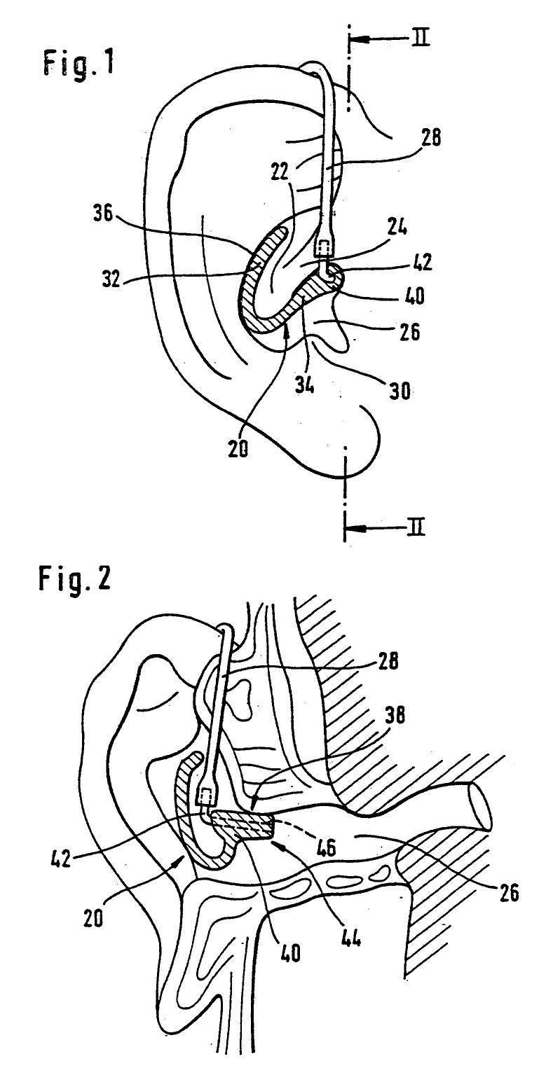

FIG. 1: a view of an ear from. the side, with the earpiece according to the first embodiment inserted in it;

FIG. 2: cross-section II-II in FIG. 1;

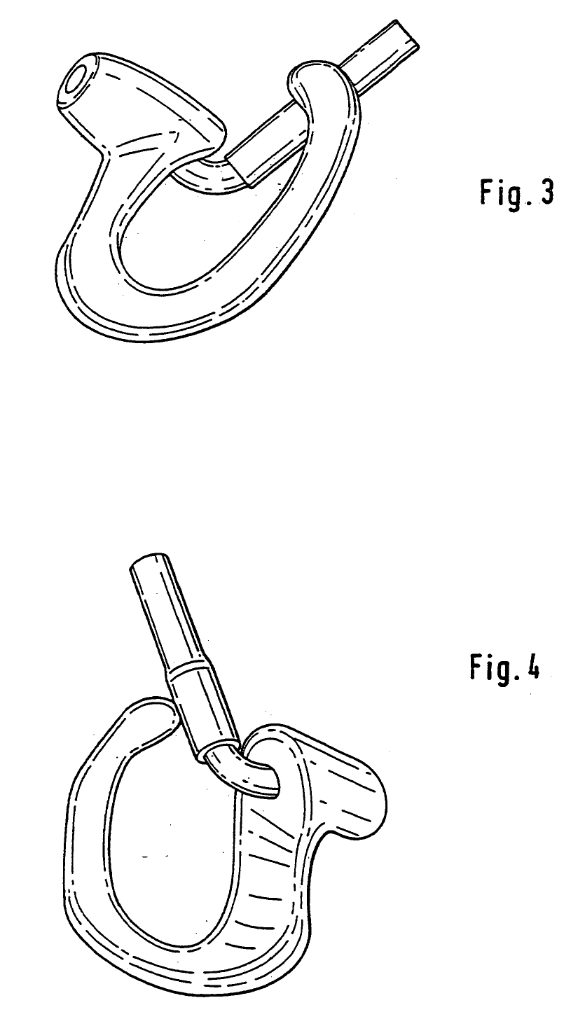

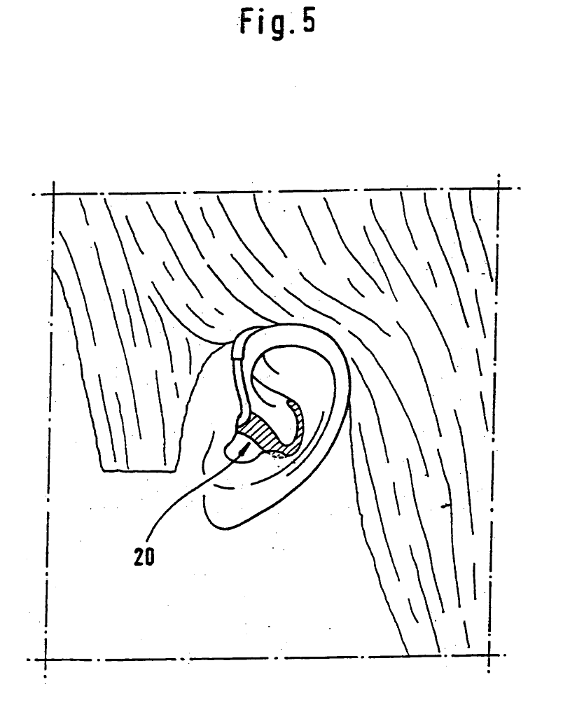

FIG. 3, FIG. 4: on a larger scale, representations of an actual manufactured earpiece of the embodiment according to FIGS. 1, 2;

FIG. 5: a view of an earpiece placed in an external ear, according to the construction corresponding to the first embodiment;

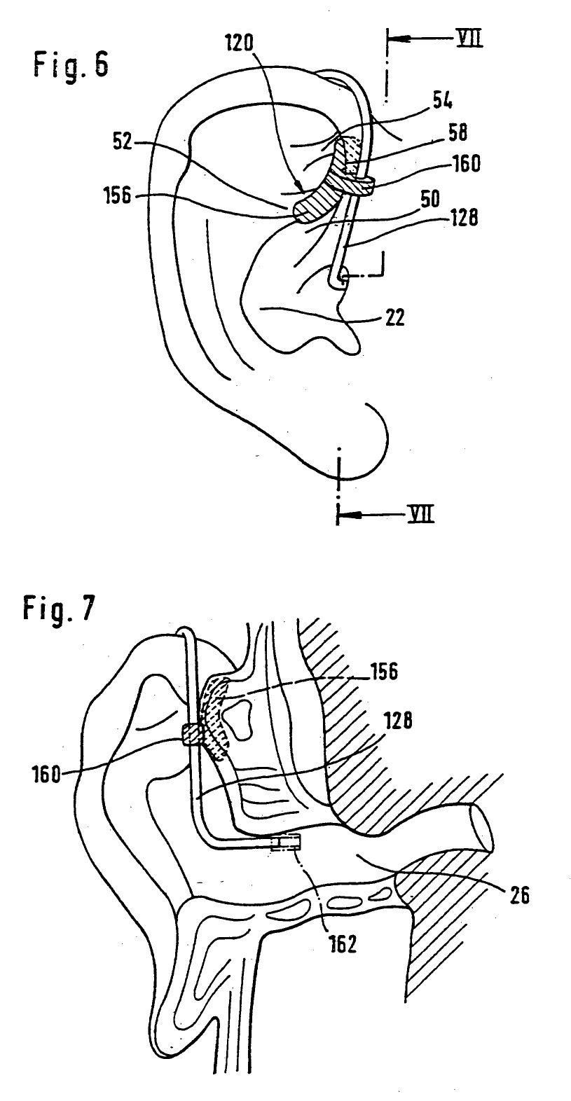

FIG. 6: a view of an ear from the side, with the earpiece according to the second embodiment inserted in it;

FIG. 7: cross-section VII-VII in FIG. 6;

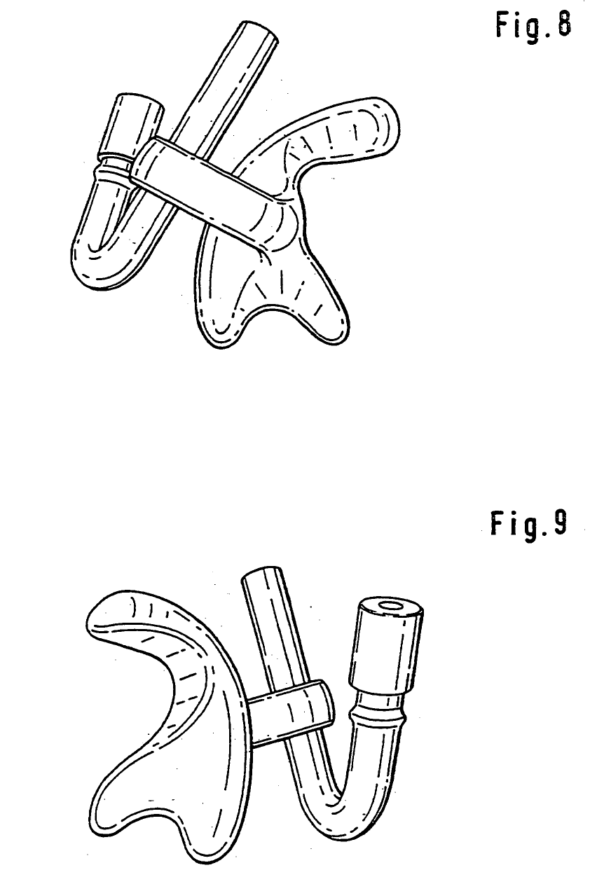

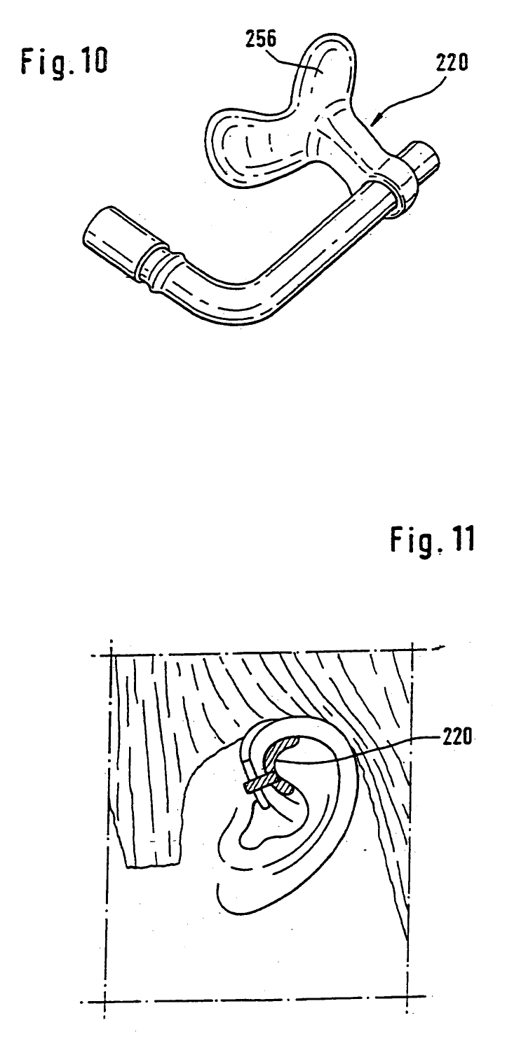

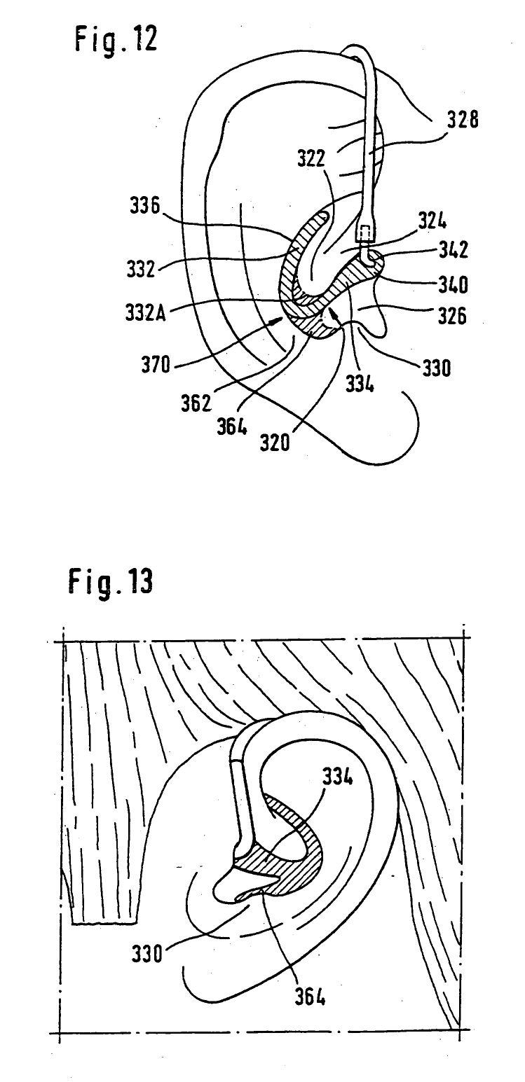

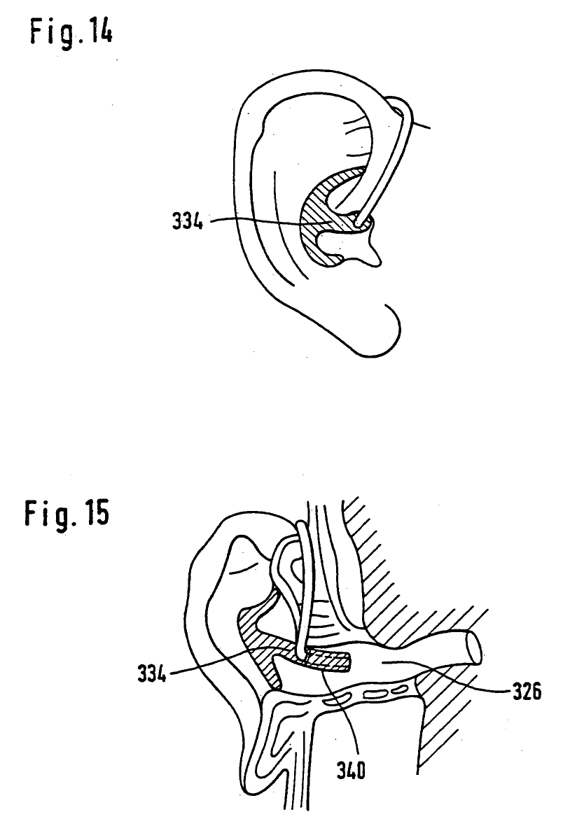

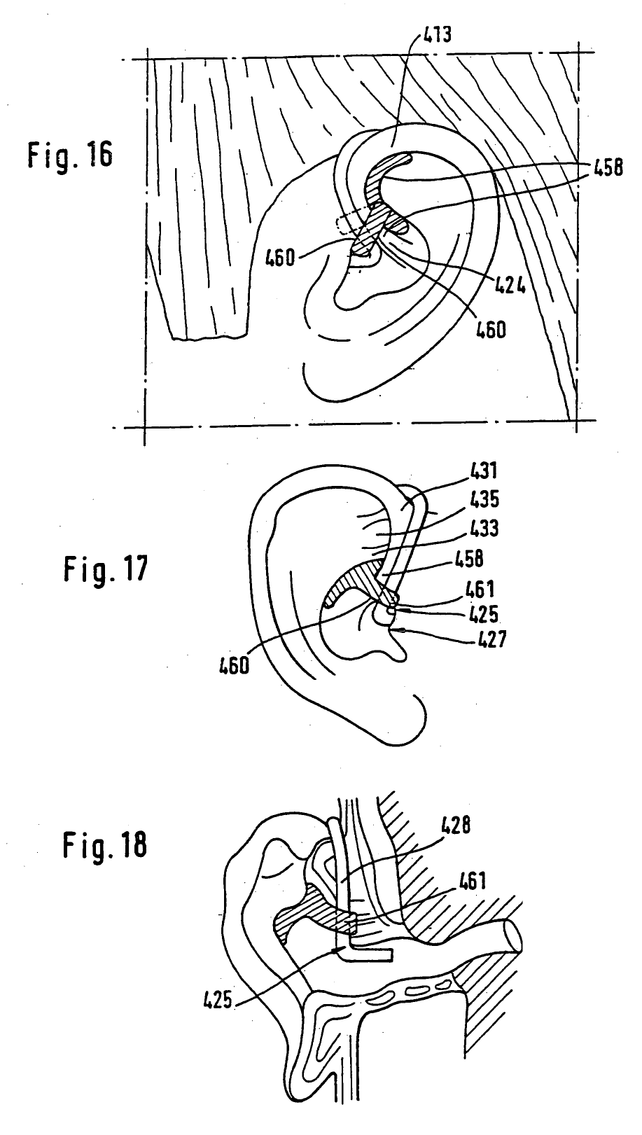

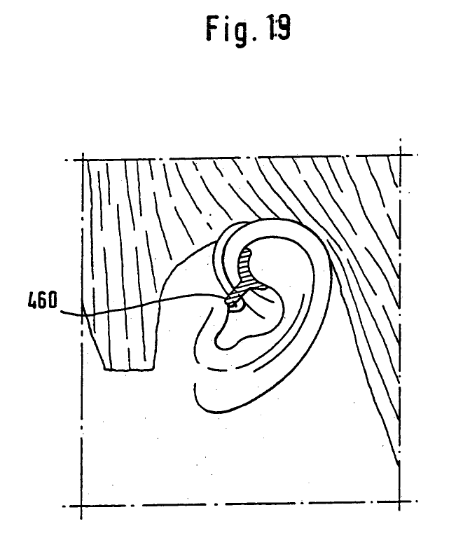

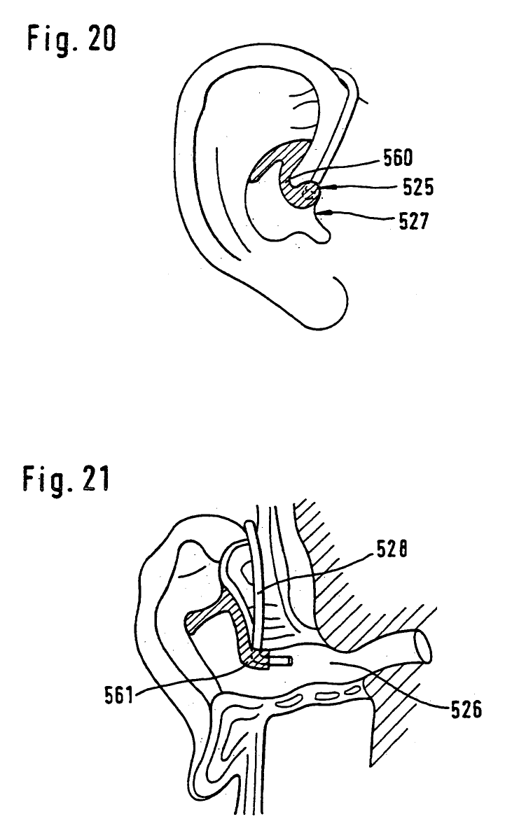

FIG. 8, FIG. 9: on a larger scale, representations of an actual manufactured earpiece of the embodiment according to FIGS. 6, 7;

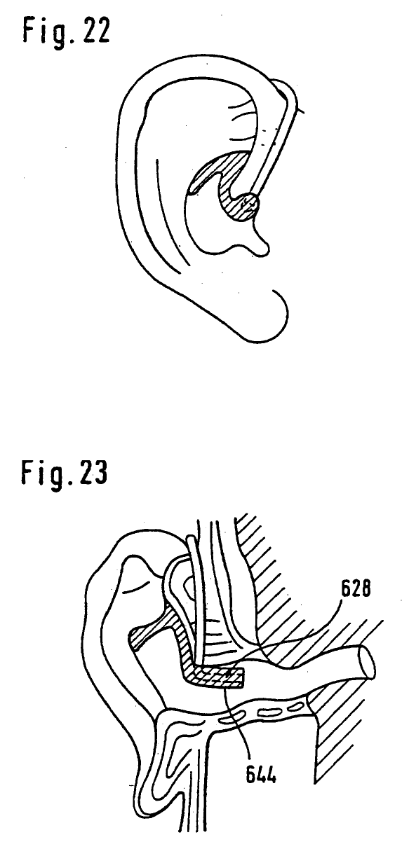

FIG. 10: an enlarged view of another embodiment of the earpiece, with a main body of a smaller size; and

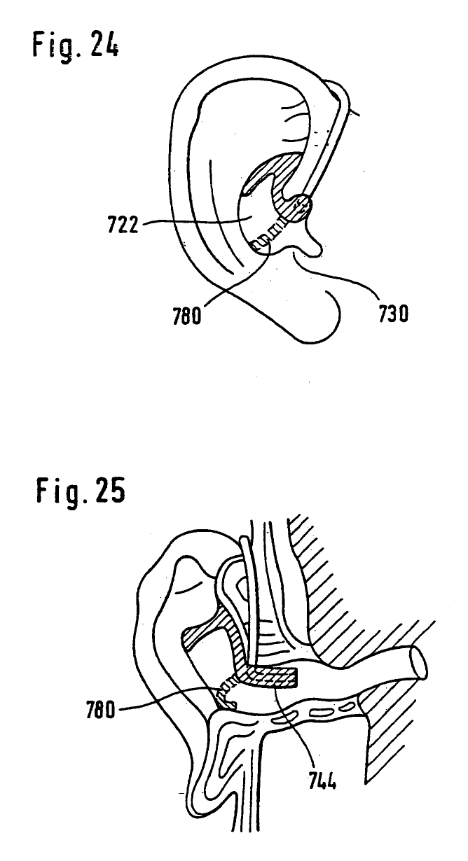

FIG. 11: a view of an earpiece according to FIG. 10, placed in an external ear;

FIG. 1 shows an earpiece, with the reference number 20, for a BTE device, which is used in the cavum conchae, referred to with the reference number 22. The crus helicis is referred to with the reference number 24, and the auditory canal, i.e. the meatus acusticus externus, is referred to with the reference number 26.

The earpiece serves to stabilize a sound tube 28 that leads to the BTE device, not shown, which tube opens into the auditory canal. For this purpose, the earpiece is individually adapted to the anatomy of the patient, for example by means of an impression-taking procedure. It essentially has the shape of a clip with two shanks 32, 34. The first shank extends in arc shape along the outer edge 36 of the cavum conchae 22 up to a point above the antitragus, referred to as 30. From there, the earpiece runs at an angle, upward, via a second shank that passes through the cavum conchae, which will be referred to as the traverse segment 34 in the following. The traverse segment runs in the direction of the porus acusticus externus 38 and there widens to an end segment 40, which serves to hold the signal conductor, in the case shown here, a sound tube angle piece 42.

As is evident from FIG. 2, the end segment 40 makes a transition into an acoustical canal tab 44 in which a bore 46 (shown with broken lines) is formed.

From the drawing, it is evident that the earpiece covers the auditory canal 26 only slightly, so that the natural auditory canal/external ear resonance is maintained. Additional stabilization of the earpiece 20 is achieved with the sound tube 28, which is rigidly connected with the angle piece 42.

In FIGS. 3 and 4, which show an earpiece according to FIGS. 1 and 2, made of plastic, the filigree structure is clearly evident, but nevertheless the earpiece can be fixed in place in the cavum conchae, in stable manner.

The cosmetic aspect of the earpiece according to the invention is best evident from FIG. 5, in which the visible surface of the earpiece 20 is shown with hatched lines. It is obvious that the design according to the invention is such that it has practically no detrimental effect on the natural appearance of the external ear.

FIGS. 6 to 11 show additional embodiments of the earpiece according to Claim 5.

The earpiece, which again is emphasized with hatched lines, as also in FIGS. 1 and 2, is referred to with the reference number 120. It is arranged in such a way that the cavum conchae remains entirely free. Instead, the earpiece is arranged in the region of the cymba conchae 50, and, in the case shown, with an extension into the region of the crus anthelicis 52, 54.

Again, the earpiece is individually adapted to the anatomy of the patient, and consists essentially of two components, namely the part 156 that provides the hold,. which is shaped to fit into the cymba conchae 50, and a hill 160, which forms the holder for the flexible sound tube 128 at its end. The sound tube 128 is inserted at an angle into the interior of the auditory canal 26, as shown in FIG. 7, and can have a so-called cerum defender 162 there, for example.

This embodiment of the earpiece has an even smaller structural volume than the earpiece according to FIGS. 1 to 5, and, as is evident from FIG. 7, it has almost no influence on the auditory canal.

FIGS. 8 and 9 show an earpiece used in practical situations, on a larger scale. The surface structure of the main body, with its multiple curves, is clearly evident; this is responsible for the accurate fit and secure seat in the cymba conchae, which prevents it from being moved. The embodiment according to FIG. 8, 9 was produced for a patient with a rather large-volume cymba conchae.

FIGS. 10 and 11 show another embodiment that was used for a patient with a significantly smaller cymba conchae. The earpiece, designated as 220, has a significantly smaller main body 256, which again is spatially curved in many places, so that the necessary undercut with the surface of the ear comes about.

From the view according to FIG. 11, it is evident that the visible part of the earpiece 220 is kept to a minimum.

Of course, all the usual materials can be used for the earpieces according to the invention, such as hot-polymerized and cold-polymerized PMMA or photopolymerizate. Because of the low volume of the earpiece, colored designs, possibly with jewelry-like applications, are also possible. Also, metals such as stainless steel, gold, silver, platinum, titanium (injection-molding or spin-casting process) can be used, and it is also possible to work with galvanic technology.

1. Earpiece for behind-the-ear (BTE) parts of hearing acoustics devices, by means of which a signal conductor, preferably a flexible one, that comes from the BTE device, such as a sound tube (28), can be positioned in the auditory canal, where the earpiece is individually adapted to the anatomy of the patient, and its part that provides the hold essentially has the shape of a clip, which follows the outer edge (36) of the cavum conchae (22) in an arc shape, at least in segments, characterized in that a shank (32) that follows the edge of the cavum conchae makes a transition, above the antitragus (30), into an angled traverse segment (34) that passes through the cavum conchae, which runs in the direction of the porus acusticus externus, and broadens to hold the signal conductor (42) at its end segment (40), which comes to rest in the upper region of the auditory canal (26).

2. Earpiece according to claim 1, characterized in that the end segment (40) makes a transition to an auditory canal tab (44) that also comes to rest only in the top region of the auditory canal (26).

3. Earpiece according to claim 2, characterized in that the auditory canal tab (44) has a bore (46) to hold the signal conductor (42).

4. Earpiece according to claim 2 or 3, characterized in that the auditory canal tab (44) has a diameter that makes up only a fraction of the diameter of the auditory canal (26).

5. Earpiece for behind-the-ear (BTE) parts of hearing acoustics devices, by means of which a signal conductor, preferably a flexible one, that comes from the BTE device, such as a sound tube (128), can be positioned in the auditory canal, where the earpiece, and particularly the part of it that provides the hold, is individually adapted to the anatomy of the patient, characterized in that the part (156) of the earpiece (120) that provides the hold is held in the cymba (50), countersunk and fitted, and carries a clip (160) that passes over the edge (58) of the external ear in the shape of an arc, the end of which clip forms the holder for the flexible signal conductor (128).

6. Earpiece according to claim 5, characterized in that the clip (160) is broadened at the end and forms a sound tube eye.

7. Earpiece according to claim 5 or 6, characterized in that the main body (156) that provides the hold extends into the region of the crus anthelicis (54).

8. Earpiece according to one of claims 1 to 7, characterized by use with cochlear implant microphones or CI BTE processors, with BTE tinnitus systems, such as broad-band noise systems (maskers or soft maskers).
